(19) United States
(12) Patent Application Publication
(10) Pub. No.: US 2019/0188693 A1
(43) Pub. Date: Jun. 20, 2019

(54) METHOD AND SYSTEM FOR TRANSFERRING A DIGITAL TOKEN BETWEEN MOBILE DEVICES

(71) Applicants: Nelson Terna IJIH, Hillsboro, OR (US); Daniel Morgan Boone BECK, Sarasota, FL (US)

(72) Inventors: Nelson Terna IJIH, Hillsboro, OR (US); Daniel Morgan Boone BECK, Sarasota, FL (US)

(21) Appl. No.: 15/848,583

(22) Filed: Dec. 20, 2017

(51) Int. Cl. G06Q 20/36; G06Q 20/16; G06Q 20/38; G06Q 20/32

(52) U.S. Cl. CPC G06Q 20/3674; G06Q 20/16; G06Q 20/3278; G06Q 20/3223; G06Q 20/3829

(57) ABSTRACT

Disclosed is a first mobile device configured for transferring a digital token to a second mobile device based on sensor data. The first mobile device comprises a first sensor, a first processor, a first memory and a first wireless transceiver. Further, the second mobile device comprises a second sensor, a second processor, a second memory and a second wireless transceiver. The first sensor is configured for generating a first sensor data representing a physical variable associated with the first mobile device. Further, the second sensor is configured for generating a second sensor data representing the physical variable associated with the second mobile device. Furthermore, transferring of the digital token is initiated based on each of the first sensor data and the second sensor data. Additionally, transferring of the digital token is based on at least one read command received from the second mobile device.

### FIELD OF THE INVENTION

The present invention relates to digital currency. In particular, the present invention relates to transferring digital currency between digital wallets.

### BACKGROUND OF THE INVENTION

Electronics payments are becoming popular around the world. This has led to continuous improvements in the electronic payment systems. Individuals often use electronic payment systems to make payments on the Internet and in the real world, for example, at the POS terminals.

Some electronic payment systems allow individuals to carry cash in electronic form in digital wallets. Thereafter, the individuals may make payments via their digital wallets. However, the available digital wallets often need an Internet connection to complete transactions. Further, the available digital wallets may not allow individuals to send money to each other. Moreover, the available digital wallets may suffer from security issues.

Accordingly, there is a need for improved methods and systems for issuing, transferring, and exchanging digital currencies that may overcome one or more of the abovementioned problems and/or limitations.

### SUMMARY OF THE INVENTION

This summary is provided to introduce a selection of concepts in a simplified form that are further described below in the Detailed Description. This summary is not intended to identify key features or essential features of the claimed subject matter. Nor is this summary intended to be used to limit the claimed subject matter's scope.

Disclosed is a first mobile device configured for transferring a digital token to a second mobile device based on sensor data. The second mobile device includes a second sensor, a second processor, a second memory and a second wireless transceiver. The first mobile device includes a first sensor configured for generating a first sensor data representing a physical variable associated with the first mobile device. The second sensor is configured for generating a second sensor data representing the physical variable associated with the second mobile device. Further, the first mobile device includes a first wireless transceiver configured for transmitting at least one memory address associated with at least one digital token based on generating of each of the first sensor data and the second sensor data. The second mobile device includes a second wireless transceiver configured for receiving the at least one memory address associated with the at least one digital token based on detecting of each of the first physical variable and the second physical variable. Further, the first wireless transceiver is configured for receiving at least one first read command and the second wireless transceiver is configured for transmitting the at least one first read command. Yet further, the first wireless transceiver is configured for transmitting the at least one digital token and the second wireless transceiver is configured for receiving the at least one digital token. Moreover, the first wireless transceiver is configured for receiving at least one erase command comprising at least one erasure data and the second wireless transceiver is configured for transmitting the at least one erase command. Further, the first mobile device includes a first memory configured for retrieving at least one digital token stored in the at least one memory address based on receiving the at least one first read command. Yet further, the second mobile device includes a second memory configured for storing the at least one digital token in the second mobile device. Further, the first memory is configured for storing the at least one erasure data in the at least one memory address based on receiving the at least one erase command.

According to further aspects, a method of wirelessly transferring a digital token between a first mobile device and a second mobile device based on sensor data is disclosed. The first mobile device includes a first sensor, a first processor, a first memory and a first wireless transceiver. The second mobile device includes a second sensor, a second processor, a second memory and a second wireless transceiver. The method includes generating, using the first sensor, a first sensor data representing a physical variable associated with the first mobile device. Further, the method includes generating, using the second sensor, a second sensor data representing the physical variable associated with the second mobile device. Yet further, the method includes transmitting, using the first wireless transceiver, at least one memory address associated with at least one digital token based on generating of each of the first sensor data and the second sensor data. Moreover, the method includes receiving, using the second wireless transceiver, the at least one memory address associated with the at least one digital token based on detecting of each of the first physical variable and the second physical variable. Further, the method includes transmitting, using the second wireless transceiver, at least one first read command associated with the at least one memory address. Yet further, the method includes receiving, using the first wireless transceiver, the at least one first read command. Moreover, the method includes retrieving, using the first memory, at least one digital token stored in the at least one memory address based on receiving the at least one first read command. Further, the method includes transmitting, using the first wireless transceiver, the at least one digital token. Yet further, the method includes receiving, using the second wireless transceiver, the at least one digital token. Moreover, the method includes storing, using the second memory, the at least one digital token in the second mobile device. Further, the method includes transmitting, using the second wireless transceiver, at least one erase command comprising at least one erasure data. Yet further, the method includes receiving, using the first wireless transceiver, the at least one erase command. Moreover, the method includes storing, using the first memory, the at least one erasure data in the at least one memory address based on receiving the at least one erase command.

Further, according to some aspects, a system for facilitating wireless transfer of a digital token between a first mobile device and a second mobile device based on sensor data is disclosed. The first mobile device may include a first sensor, a first processor, a first memory and a first wireless transceiver. Further, the second mobile device may include a second sensor, a second processor, a second memory and a second wireless transceiver. Accordingly, the system may include a communication device configured for receiving a first sensor data representing a physical variable associated with the first mobile device. Further, the communication device may be configured for receiving a second sensor data representing the physical variable associated with the second mobile device. Further, the communication device may be configured for transmitting an indication of a transfer event to the first mobile device and the second mobile device. Additionally, the system may include a processing device configured for analyzing each of the first sensor data and the second sensor data. Further, the processing device may be configured for detecting the transfer event based on the said analysis. Accordingly, the first wireless transceiver may be configured for receiving the indication of the transfer event from the communication device. Further, the first wireless transceiver may be configured for transmitting at least one memory address associated with at least one digital token based on receiving the indication of the transfer event. Accordingly, the second wireless transceiver may be configured for receiving the indication of the transfer event from the communication device. Further, the second wireless transceiver may be configured for receiving the at least one memory address associated with the at least one digital token based on the indication of the transfer event. Additionally, the first wireless transceiver may be configured for receiving at least one first read command.

Accordingly, the second wireless transceiver may be configured for transmitting the at least one first read command. Furthermore, the first wireless transceiver may be configured for transmitting the at least one digital token. Further, the second wireless transceiver may be configured for receiving the at least one digital token. Moreover, the first wireless transceiver may be configured for receiving at least one erase command comprising at least one erasure data. Accordingly, the second wireless transceiver may be configured for transmitting the at least one erase command. Additionally, the first memory may be configured for retrieving at least one digital token stored in the at least one memory address based on receiving the at least one first read command. Further, the second memory may be configured for storing the at least one digital token in the second mobile device. Further, the first memory may be configured for storing the at least one erasure data in the at least one memory address based on receiving the at least one erase command.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of a platform consistent with various embodiments of the present disclosure.

FIG. 2 is a block diagram of a first mobile device configured for transferring a digital token to a second mobile device based on sensor data, in accordance with some embodiments.

FIG. 3 illustrates a flowchart of a method for wirelessly transferring a digital token between a first mobile device and a second mobile device based on sensor data, in accordance with some embodiments.

FIG. 4 illustrates a flowchart of a method for confirming successful transfer of the one or more digital tokens, in accordance with some embodiments.

FIG. 5 illustrates a flowchart of a method for obtaining the at least one actual data in encrypted form, in accordance with some embodiments.

FIG. 6 illustrates a flowchart of a method for encrypting the one or more digital tokens, in accordance with some embodiments.

FIG. 7 illustrates a flowchart of a method for storing the one or more digital tokens in encrypted form, in accordance with some embodiments.

FIG. 8 illustrates a flowchart of a method for producing the at least one erasure data, in accordance with some embodiments.

FIG. 9 illustrates a flowchart of a method for validating the amount of money to be transferred, in accordance with some embodiments.

FIG. 10 illustrates a flowchart of a method for obtaining an acceptance for transferring the one or more digital tokens, in accordance with some embodiments.

FIG. 11 illustrates a flowchart of a method for checking the transferred amount of money, in accordance with some embodiments.

FIG. 12 illustrates a flowchart of a method for authenticating the transaction, in accordance with some embodiments.

FIG. 13 is a block diagram of a first mobile device configured for transferring a digital token to a second mobile device based on sensor data, in accordance with some embodiments.

FIG. 14 shows a staging table in accordance with an exemplary embodiment.

FIG. 15 shows a storage element in accordance with an exemplary embodiment.

FIG. 16 is a sequence diagram showing the communication between a sending device and a receiving device, in accordance with some embodiments.

FIG. 17 illustrates the first mobile device in accordance with some embodiments.

FIG. 18 illustrates an exemplary computing system that may be employed to implement processing functionality for various embodiments.

### DETAILED DESCRIPTION OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of transferring digital tokens, embodiments of the present disclosure are not limited to use only in this context.

### Overview

According to some aspects, the present disclosure provides an offline, radio frequency-enabled device with its own operating system (OS) designed to transfer digital data to another device wirelessly. This digital data cannot be duplicated, such that it cannot exist on more than one device at a time. The disclosed device may be used to exchange digital currency backed by cryptocurrencies, such as ‘bitcoins’ and other so-called ‘altcoins’.

According to some aspects, the disclosed device may incorporate a touching (or tapping) feature, wherein hardware technology (such as sensors) may be used to initiate transactions with other devices. A sending transaction may be initiated when a sending user uses her device to tap the device of a receiving user. The receiving user can also initiate a receiving transaction and wait for the sending user to tap her device. Upon physical contact (or tapping), sensors in both devices detect the physical contact and automatically pair the devices via radio frequency allowing for the transfer of digital currency from one device to the other. The sending user may simply enter an amount of money intended to be sent to the receiving user's device using a number pad. This amount of money may be sent to the receiving device. Alternatively, the receiving user may enter the amount requested from the sending user on the receiving device by entering the amount which may be shown on the screen for both devices. Moreover, the user device may be loaded with new currency via special dispensing devices that enable user devices to be loaded with new digital currency denominations.

According to some aspects, the disclosed device's firmware may be designed to hold and transfer digital currency data. This data may be comprised of a plurality of tiny data files (digital tokens) each representing a unit (or denomination) of a currency. Moreover, each individual file is not allowed exist on more than one device. Therefore, each individual file is deleted, when transferred from one device to another. Accordingly, the device is capable of transferring exclusive ownership of a currency from one user to another, without the sending device being able to keep a copy of the data once a transfer is complete.

According to some embodiments, a method for offline trading cryptocurrencies is disclosed. The method increases ease-of-use of cryptocurrencies for businesses and consumers. The disclosed method may be used for issuing, transferring, and exchanging digital currencies backed by real-life blockchain currencies, such as bitcoin. The digital currency is “invisible” in the sense that nobody will able to see the digital currency (tokens) either digitally or physically.

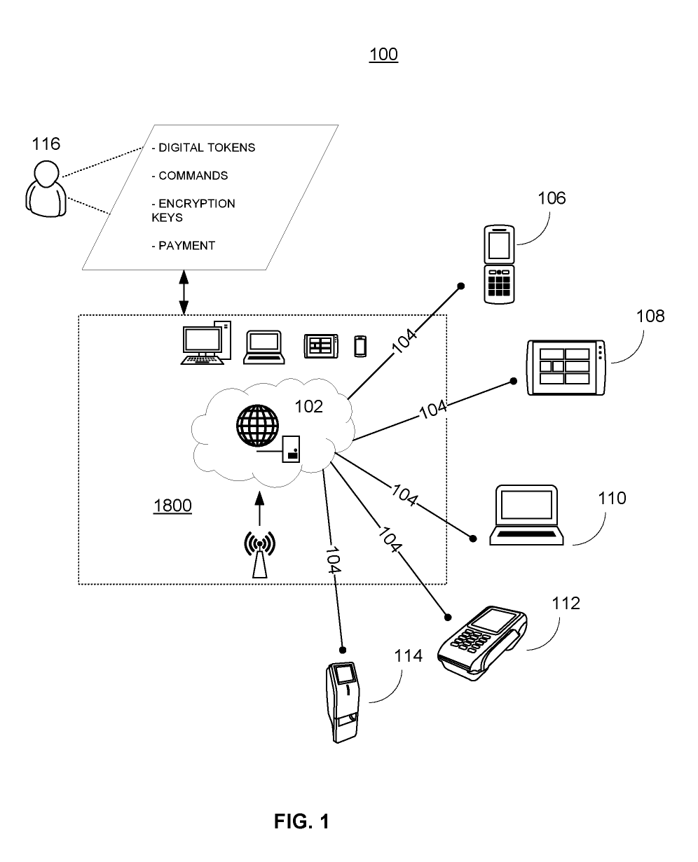

Referring now to figures, FIG. 1 is an illustration of a platform 100 consistent with various embodiments of the present disclosure. By way of non-limiting example, the online platform 100 for wirelessly transferring a digital token may be hosted on a centralized server 102, such as, for example, a cloud computing service. The centralized server 102 may communicate with other network entities, such as, for example mobile devices 106 (such as a smartphone, a laptop, a tablet computer etc.), special electronic devices 108, other electronic devices 110 (such as desktop computers, etc.), POS terminals 112, Kiosks 114 over a communication network 104, such as, but not limited to, the Internet. Further, users of the platform may include one or more relevant parties such as users, officials of financial institutions, and system administrators. Accordingly, electronic devices operated by the one or more relevant parties may be in communication with the platform 100.

A user 116, such as the one or more relevant parties, may access platform 100 through a software application. The software application may be embodied as, for example, but not be limited to, a website, a web application, a desktop application, and a mobile application compatible with a computing device 1800.

In some embodiments, two individuals with mobile devices (such as the mobile devices 106) may transfer digital tokens (digital currency) from one mobile device to another. Further, the two individuals may transfer the digital tokens in an offline mode, without connecting to the online platform 100.

In some embodiments, an individual with a mobile device may transfer digital tokens (digital currency) to a POS terminal. Further, this transaction may be performed in an offline mode, without connecting to the online platform 100.

In some embodiments, an individual with a mobile device may load digital tokens (digital currency) into their device via a kiosk in the kiosks 114. Further, an individual with a mobile device may load digital tokens (digital currency) into their device via a desktop in the electronic devices 110. The digital tokens may be issued by government agencies, financial institutions or private businesses. For example, the digital currency may be called Wallabit. Further, crypto-currencies like Bitcoin may also be used.

In some embodiments, an electronic device in the special electronic devices 108 may include an offline, radio frequency-enabled, payment device with customized operating system and firmware, and associated methods for storing and transferring digital currency to other devices wirelessly. Further, the electronic device may be provided by the same organization which provides a digital currency.

Further, according to some aspects, a system for facilitating wireless transfer of a digital token between a first mobile device and a second mobile device based on sensor data is disclosed. The system may, in some embodiments, be implemented in the form of the online platform 100. Accordingly, the system may be configured to interface with each of the first mobile device and the second mobile device. Further, the first mobile device may include a first sensor, a first processor, a first memory and a first wireless transceiver. Similarly, the second mobile device may include a second sensor, a second processor, a second memory and a second wireless transceiver.

Furthermore, the system may include a communication device configured for receiving a first sensor data representing a physical variable associated with the first mobile device. For example, the physical variable may include acceleration of the first mobile device. Accordingly, the first sensor data may include a first acceleration value greater than a predetermined threshold that may correspond to, for example, a bump/tap impinged on the first mobile device. Additionally, the first sensor data may include a first timestamp corresponding to the first acceleration value representing a time at which the bump/tap was impinged on the first mobile device.

Further, the communication device may be configured for receiving a second sensor data representing the physical variable associated with the second mobile device. For example, the second sensor data may include a second acceleration value greater than the predetermined threshold that may correspond to, for example, a bump/tap impinged on the second mobile device. Additionally, the second sensor data may include a second timestamp corresponding to the second acceleration value representing a time at which the bump/tap was impinged on the second mobile device.

Further, the communication device may be configured for transmitting an indication of a transfer event to each of the first mobile device and the second mobile device. The transfer event may signify initiation of transfer of at least one digital token from the first mobile device to the second mobile device. For example, the transfer event may correspond to both the first mobile device and the second mobile device being bumped together.

Additionally, the system may include a processing device configured for analyzing each of the first sensor data and the second sensor data. For example, the analyzing may involve determining a correlation between the first sensor data and the second sensor data with regards to one or more variables. For instance, the analyzing may include determining that the first timestamp and the second timestamp are identical within a predetermined range of tolerance (e.g. 100 milli-seconds). In other words, the first acceleration value and the second acceleration value are correlated in time. Alternatively, in another instance, the analyzing may include determining that each of the first sensor data and the second sensor data are correlated with regards to a magnitude of sensor data. For example, each of the first sensor data and the second sensor data may be generated as results of being exposed to a common physical action such as a particular sound, image or motion.

Accordingly, in an exemplary scenario, a first user of the first user device may move the first mobile device in a predetermined path (e.g. forming a triangle in space) during a first time period. Likewise, the second user of the second user device may move the second mobile device in the predetermined path (i.e. a triangle) during a second time period different from the first time period. Accordingly, the processing device may be configured for analyzing the first sensor data and the second sensor data to determine a commonality in pattern corresponding to magnitudes of sensor data (e.g. 2D and/or 3D acceleration values).

Further, the processing device may be configured for detecting the transfer event based on the analysis. For example, each of the first user and the second user may bump the first mobile device and the second mobile device together to express an intent to initiate transfer of at least one digital token from the first mobile device to the second mobile device. Accordingly, the bump action signifying an express intent to initiate transfer of the at least one digital token may be detected by the processing device based on the analyzing.

Accordingly, the first wireless transceiver of the first mobile device may be configured for receiving the indication of the transfer event from the communication device of the system. Further, the first wireless transceiver may be configured for transmitting at least one memory address associated with at least one digital token based on receiving the indication of the transfer event. Accordingly, the second wireless transceiver may be configured for receiving the indication of the transfer event from the communication device. Further, the second wireless transceiver may be configured for receiving the at least one memory address associated with the at least one digital token based on the indication of the transfer event. Additionally, the first wireless transceiver may be configured for receiving at least one first read command. Accordingly, the second wireless transceiver may be configured for transmitting the at least one first read command. Furthermore, the first wireless transceiver may be configured for transmitting the at least one digital token. Further, the second wireless transceiver may be configured for receiving the at least one digital token. Moreover, the first wireless transceiver may be configured for receiving at least one erase command comprising at least one erasure data. Accordingly, the second wireless transceiver may be configured for transmitting the at least one erase command. Additionally, the first memory may be configured for retrieving at least one digital token stored in the at least one memory address based on receiving the at least one first read command. Further, the second memory may be configured for storing the at least one digital token in the second mobile device. Further, the first memory may be configured for storing the at least one erasure data in the at least one memory address based on receiving the at least one erase command.

Further, in some embodiments, the system may be configured for generating, storing and distributing digital tokens. Additionally, the system may also be configured for receiving requests for authenticating one or more of a transaction claim identifier, a memory address associated with a digital token and a digital token. Accordingly, the system may be configured for authenticating validity of one or more of a transaction claim identifier, a memory address associated with a digital token and a digital token.

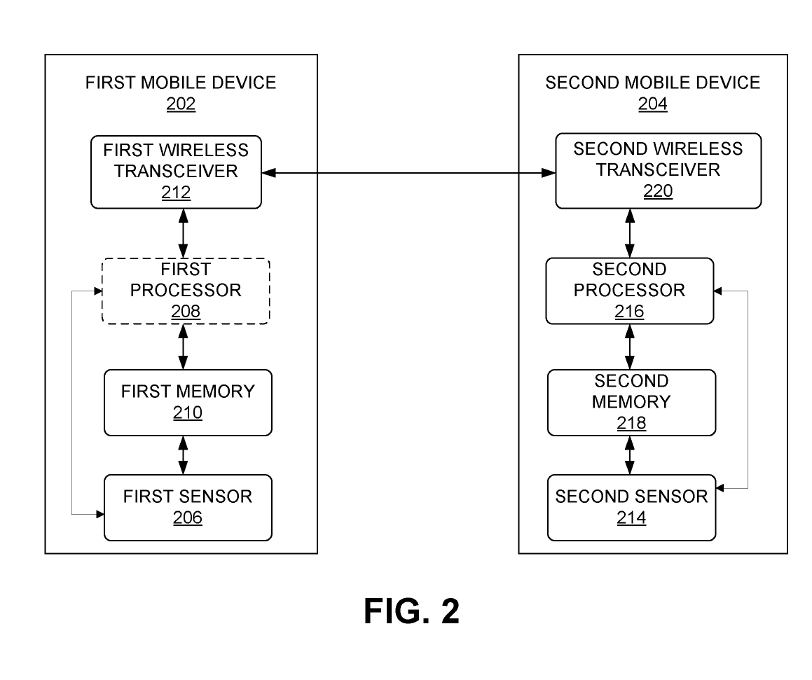

FIG. 2 is a block diagram of a first mobile device 202 configured for transferring a digital token to a second mobile device 204 based on sensor data, in accordance with some embodiments. The first mobile device 202 may include a first sensor 206, a first processor 208, a first memory 210 and a first wireless transceiver 212. The second mobile device 204 may include a second sensor 214, a second processor 216, a second memory 218 and a second wireless transceiver 220.

Accordingly, the first sensor 206 may be configured for generating a first sensor data representing a physical variable associated with the first mobile device 202. Further, the second sensor 214 may be configured for generating a second sensor data representing the physical variable associated with the second mobile device 204. For example, the first sensor 206 and the second sensor 214 may include one or more of touch sensors, proximity sensors, pressure sensors, ultrasonic sensors, motion sensors, temperature sensors, and IR sensors.

In an exemplary embodiment, the first sensor 206 and the second sensor 214 include touch sensors which may be configured to record a vibration pattern, when the first mobile device 202 is tapped with the second mobile device 204. Accordingly, the physical variable associated with the first mobile device 202 and the second mobile device 204 may be the vibration pattern. The vibration patterns obtained by each the first sensor 206 and the second sensor 214 may be used to pair (or synchronize) the first mobile device 202 and the second mobile device 204. For example, the first mobile device 202 and the second mobile device 204 may be paired using a wireless connection, such as, but not limited to, a Bluetooth™ connection, Wi-Fi connection, and ZigBee connection.

Further, the first wireless transceiver 212 may be configured for transmitting one or more memory addresses associated with one or more digital tokens based on generating of each of the first sensor data and the second sensor data. Further, the second wireless transceiver 220 may be configured for receiving the one or more memory addresses associated with the one or more digital tokens based on the detecting of each of the first physical variable and the second physical variable.

Further, the first wireless transceiver 212 may be configured for receiving one or more first read commands. Further, the second wireless transceiver 220 may be configured for transmitting the one or more first read commands.

Further, the first wireless transceiver 212 may be configured for transmitting the one or more digital tokens. Further, the second wireless transceiver 220 may be configured for receiving the one or more digital tokens.

Further, the first wireless transceiver 212 may be configured for receiving one or more erase commands including at least one erasure data. Further, the second wireless transceiver 220 may be configured for transmitting the one or more erase commands.

Further, the first memory 210 may be configured for retrieving one or more digital tokens stored in the one or more memory addresses based on receiving the one or more first read commands. The second memory 218 may be configured for storing the one or more digital tokens in the second mobile device 204. Further, the first memory 210 may be configured for storing the at least one erasure data in the one or more memory addresses based on receiving the one or more erase commands.

In some embodiments, the first wireless transceiver 212 may be further configured for receiving one or more second read commands associated with the one or more memory addresses. Further, using the second wireless transceiver 220 may be configured for transmitting the one or more second read commands. Moreover, the first wireless transceiver 212 may be configured for transmitting at least one actual data stored in the one or more memory addresses. The second wireless transceiver 220 may be further configured for receiving the at least one actual data. Further, the second processor 216 may be configured for comparing the at least one actual data with the at least one erasure data. Further, the second processor 216 may be configured for determining a successful transfer of the one or more digital tokens based on a result of the comparing. The first memory 210 may be further configured for retrieving the at least one actual data stored in the one or more memory addresses based on receiving the one or more second read commands.

In some embodiments, the first wireless transceiver 212 may be further configured for receiving a second public key associated with the second mobile device 204. Further, the second wireless transceiver 220 may be configured for transmitting the second public key. Further, the first processor 208 may be configured for encrypting the at least one actual data using the second public key and the second processor 216 may be configured for decrypting the at least one actual data using a second private key associated with the second public key.

In some embodiments, the first wireless transceiver 212 may be further configured for receiving a second public key associated with the second mobile device 204. Further, the second wireless transceiver 220 may be configured for transmitting the second public key. The first processor 208 may be further configured for decrypting the one or more digital tokens based on a first private key associated with the first mobile device 202 and encrypting the one or more digital tokens based on the second public key.

In some embodiments, the second processor 216 may be further configured for decrypting the one or more digital tokens based on the second private key. Further, the second processor 216 may be configured for generating each of a third private key and a third public key associated with the second mobile device 204 and encrypting one or more digital tokens based on the third public key. The second memory 218 may be further configured for storing the one or more digital tokens subsequent to encrypting the one or more digital tokens with the third private key.

In some embodiments, the second processor 216 may be further configured for generating one or more random numbers and generating the at least one erasure data based on the one or more random numbers.

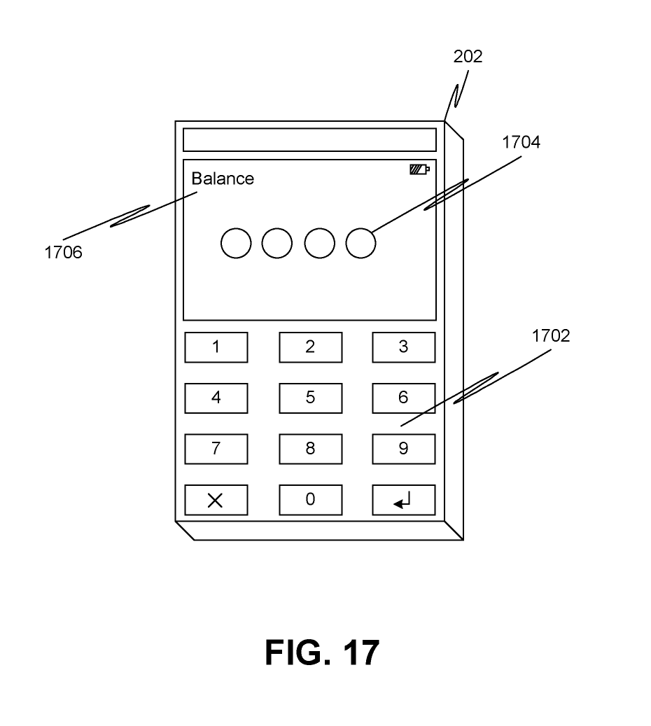

In some embodiments, the first mobile device 202 may further include a first input device configured for receiving a sender indication of an amount of money to be transferred by the first mobile device 202. Further, a digital token of the one or more digital tokens may be associated with a predetermined monetary value. FIG. 17 illustrates the first mobile device 202 in accordance with some embodiments. The first mobile device 202 includes a first input device 1702 (a number pad). A user of the first mobile device 202 may use the first input device 1702 to provide indication of an amount of money to be transferred by the first mobile device 202. The amount of money to be transferred may be displayed on a display screen 1704. Further, the balance in the first mobile device 202 may be shown in a corner 1706 of the display screen 1704. The first mobile device 202 may also include a touch sensor on one or both of the front side and back side of the first mobile device 202.

Further, the first wireless transceiver 212 may be configured for transmitting the sender indication of the amount of money. Similarly, the second wireless transceiver 220 may be configured for receiving the sender indication of the amount of money. Further, the second mobile device 204 may include a second input device configured for receiving a receiver indication of an amount of money to be received by the second mobile device 204. Further, the second processor 216 may be configured for comparing the sender indication with the receiver indication and confirming the amount of money to be transferred. Further, the transmitting of the one or more first read commands may be based on the confirming.

In some embodiments, the first wireless transceiver 212 may be further configured for receiving a receiver indication of the amount of money. Further, the second wireless transceiver 220 may be configured for transmitting the receiver indication of the amount of money. Further, the second input device may be configured for receiving a receiver indication of amount of money to be received by the second mobile device 204. Further, the first mobile device 202 may include a first display unit configured for displaying the receiver indication of the amount of money. The first input device may be configured for receiving an acceptance associated with the receiver indication. Further, the transmitting of the one or more first read commands may be based on the acceptance.

In some embodiments, the first processor 208 may be further configured for analyzing the one or more first read commands. The first processor 208 may be configured for determining a transferred amount of money based on the analyzing. Further, the first processor 208 may be configured for comparing the transferred amount with the amount of money to be transferred. Further, transmitting one or more of the one or more memory addresses may be based on a result of comparing the transferred amount with the amount of money to be transferred.

In some embodiments, the first wireless transceiver 212 may be further configured for receiving a transaction claim identifier associated with the second mobile device 204. Further, the second wireless transceiver 220 may be configured for transmitting the transaction claim identifier. The first processor 208 may be further configured for validating the authenticity of the transaction claim identifier. Further, transmitting of the one or more memory addresses may be further based on the validating.

In some embodiments, the second processor 216 may be further configured for validating the authenticity of the one or more memory addresses based on at least one characteristic of the one or more memory addresses.

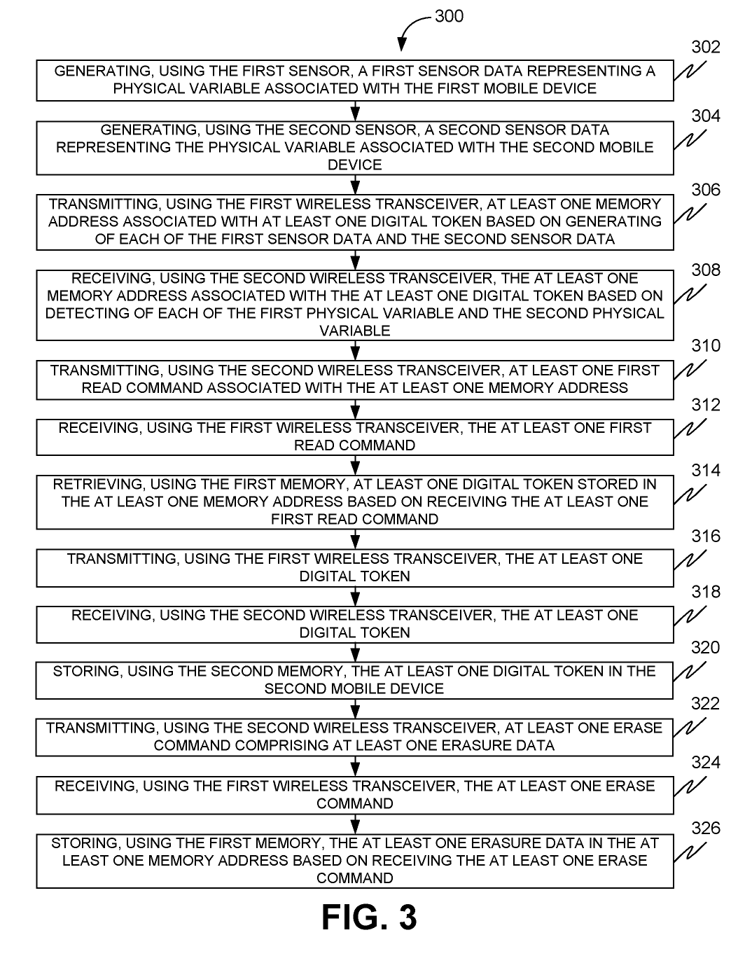

FIG. 3 illustrates a flowchart of a method 300 for wirelessly transferring a digital token between a first mobile device 202 and a second mobile device 204 based on sensor data, in accordance with some embodiments. At 302, the method 300 may include generating, using the first sensor 206, a first sensor data representing a physical variable associated with the first mobile device 202. Further, at 304, the method 300 may include generating, using the second sensor 214, a second sensor data representing the physical variable associated with the second mobile device 204. At 306, the method 300 may include transmitting, using the first wireless transceiver 212, one or more memory addresses associated with one or more digital tokens based on generating of each of the first sensor data and the second sensor data. Then, at 308, the method 300 may include receiving, using the second wireless transceiver 220, the one or more memory addresses associated with the one or more digital tokens based on detecting of each of the first physical variable and the second physical variable. Further, at 310, the method 300 may include transmitting, using the second wireless transceiver 220, one or more first read commands associated with the one or more memory addresses. At 312, the method 300 may include receiving, using the first wireless transceiver 212, the one or more first read commands. Further, at 314, the method 300 may include retrieving, using the first memory 210, one or more digital tokens stored in the one or more memory addresses based on receiving the one or more first read commands. At 316, the method 300 may include transmitting, using the first wireless transceiver 212, the one or more digital tokens. Further, at 318, the method 300 may include receiving, using the second wireless transceiver 220, the one or more digital tokens. At 320, the method 300 may include storing, using the second memory 218, the one or more digital tokens in the second mobile device 204. Further, at 322, the method 300 may include transmitting, using the second wireless transceiver 220, one or more erase commands including at least one erasure data. At 324, the method 300 may include receiving, using the first wireless transceiver 212, the one or more erase commands. Further, at 326 the method 300 may include storing, using the first memory 210, the at least one erasure data in the one or more memory addresses based on receiving the one or more erase commands. In some embodiments, the method 300 may further include validating, using the second processor 216, authenticity of the one or more memory addresses based on at least one characteristic of the one or more memory addresses.

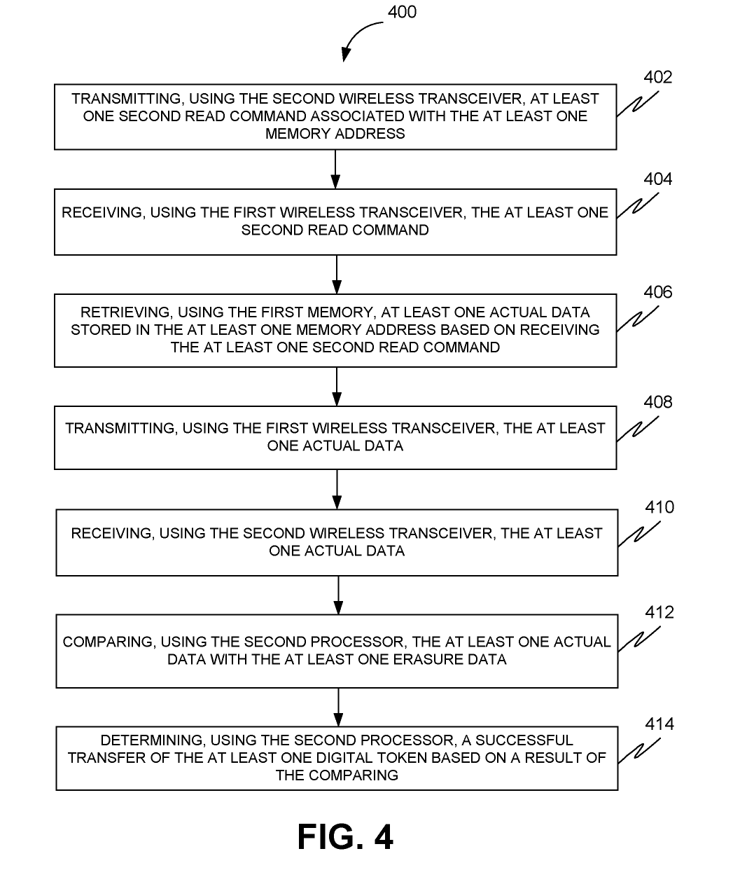

FIG. 4 illustrates a flowchart of a method 400 for confirming successful transfer of the one or more digital tokens, in accordance with some embodiments. At 402, the method 400 may include transmitting, using the second wireless transceiver 220, one or more second read commands associated with the one or more memory addresses. Further, at 404, the method 400 may include receiving, using the first wireless transceiver 212, the one or more second read commands. At 406, the method 400 may include retrieving, using the first memory 210, at least one actual data stored in the one or more memory addresses based on receiving the one or more second read commands. Next, at 408, the method 400 may include transmitting, using the first wireless transceiver 212, the at least one actual data. At 410, the method 400 may include receiving, using the second wireless transceiver 220, the at least one actual data. Then, at 412, the method 400 may include comparing, using the second processor 216, the at least one actual data with the at least one erasure data. Further, the method 400 may include determining, using the second processor 216, a successful transfer of the one or more digital tokens based on a result of the comparing.

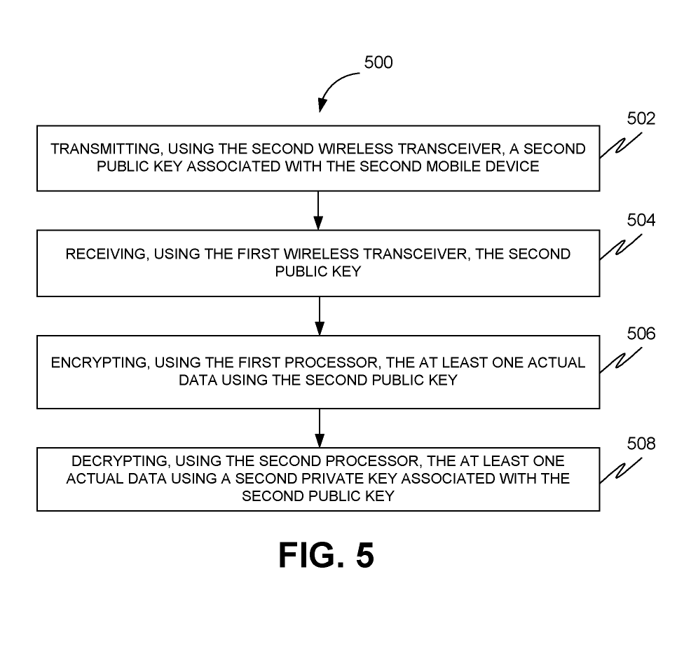

FIG. 5 illustrates a flowchart of a method 500 for obtaining the at least one actual data in encrypted form, in accordance with some embodiments. At 502, the method 500 may include transmitting, using the second wireless transceiver 220, a second public key associated with the second mobile device 204. Further, at 504, the method 500 may include receiving, using the first wireless transceiver 212, the second public key. At 506, the method 500 may include encrypting, using the first processor 208, the at least one actual data using the second public key. Further, at 508, the method 500 may include decrypting, using the second processor 216, the at least one actual data using a second private key associated with the second public key.

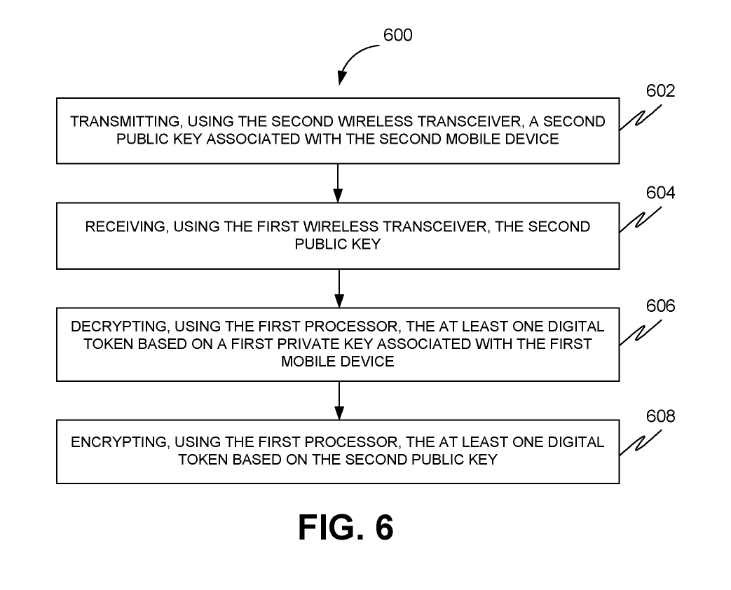

FIG. 6 illustrates a flowchart of a method 600 for encrypting the one or more digital tokens, in accordance with some embodiments. At 602, the method 600 may include transmitting, using the second wireless transceiver 220, a second public key associated with the second mobile device 204. Further, at 604, the method 600 may include receiving, using the first wireless transceiver 212, the second public key. Next, at 606, the method 600 may include decrypting, using the first processor 208, the one or more digital tokens based on a first private key associated with the first mobile device 202. Then, at 608, the method 600 may include encrypting, using the first processor 208, the one or more digital tokens based on the second public key.

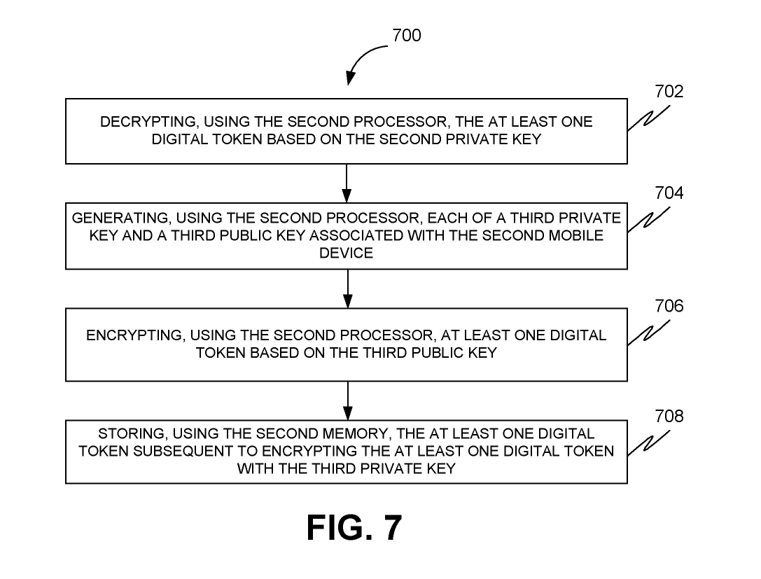

FIG. 7 illustrates a flowchart of a method 700 for storing the one or more digital tokens in encrypted form, in accordance with some embodiments. At 702, the method 700 may include decrypting, using the second processor 216, the one or more digital tokens based on the second private key. Next, at 704, the method 700 may include generating, using the second processor 216, each of a third private key and a third public key associated with the second mobile device 204. Then, at 706, the method 700 may include encrypting, using the second processor 216, one or more digital tokens based on the third public key. Further, at 708, the method 700 may include storing, using the second memory 218, the one or more digital tokens subsequent to encrypting the one or more digital tokens with the third private key.

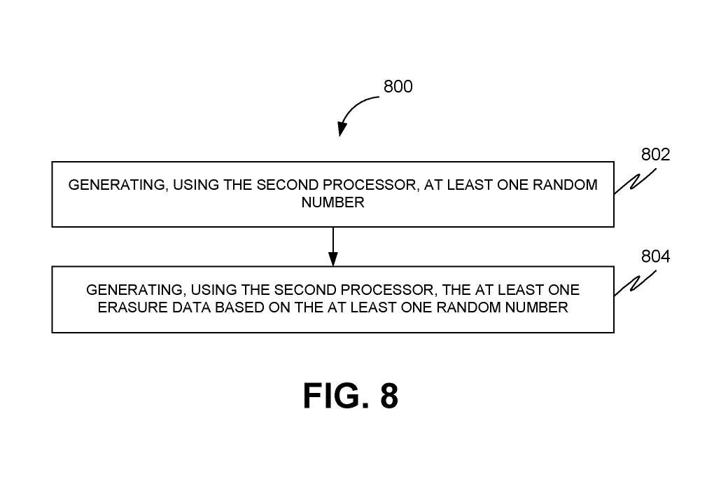

FIG. 8 illustrates a flowchart of a method 800 for producing the at least one erasure data, in accordance with some embodiments. At 802, the method 800 may include generating, using the second processor 216, one or more random numbers. Then, at 804, the method 800 may include generating, using the second processor 216, the at least one erasure data based on the one or more random numbers.

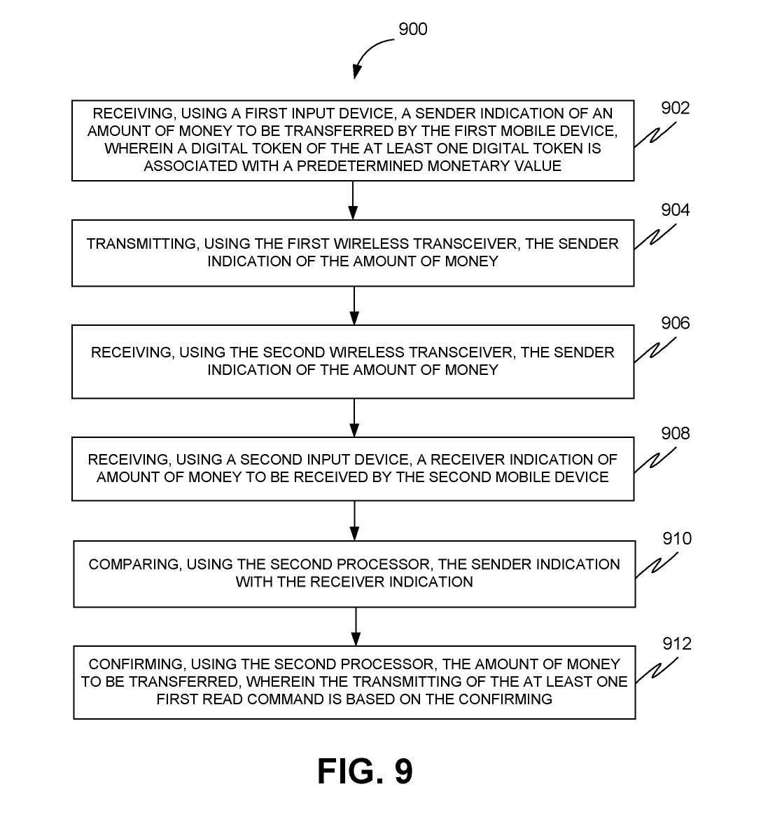

FIG. 9 illustrates a flowchart of a method 900 for validating the amount of money to be transferred, in accordance with some embodiments. At 902, the method 900 may include receiving, using a first input device, a sender indication of an amount of money to be transferred by the first mobile device 202. Further, a digital token of the one or more digital tokens may be associated with a predetermined monetary value. At 904, the method 900 may include transmitting, using the first wireless transceiver 212, the sender indication of the amount of money. Further, at 906, the method 900 may include receiving, using the second wireless transceiver 220, the sender indication of the amount of money. Next, at 908, the method 900 may include receiving, using a second input device, a receiver indication of amount of money to be received by the second mobile device 204. Further, at 910, the method 900 may include comparing, using the second processor 216, the sender indication with the receiver indication. At 912, the method 900 may include confirming, using the second processor 216, the amount of money to be transferred. Further, the transmitting of the one or more first read commands may be based on the confirming.

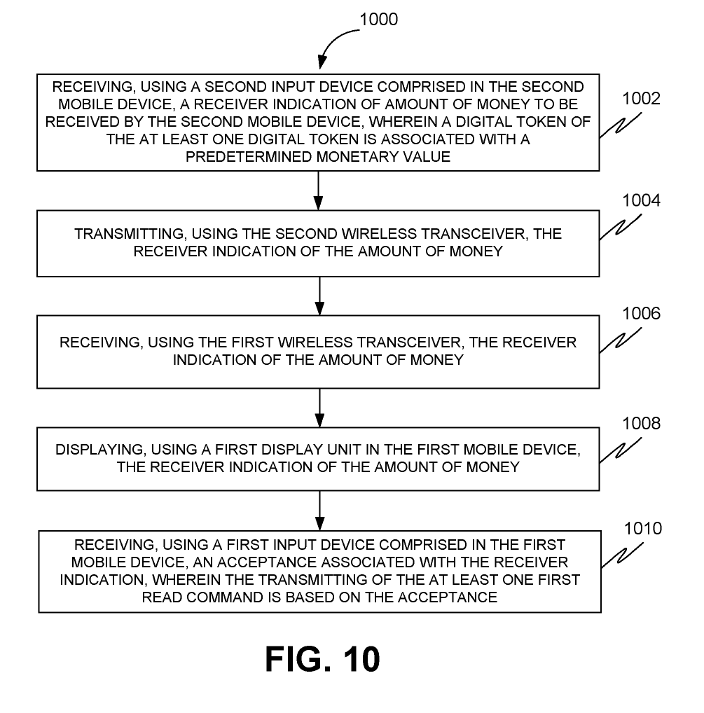

FIG. 10 illustrates a flowchart of a method 1000 for obtaining an acceptance for transferring the one or more digital tokens, in accordance with some embodiments. At 1002, the method 1000 may include receiving, using a second input device comprised in the second mobile device 204, a receiver indication of amount of money to be received by the second mobile device 204. Further, a digital token of the one or more digital tokens may be associated with a predetermined monetary value. Further, at 1004, the method 1000 may include transmitting, using the second wireless transceiver 220, the receiver indication of the amount of money. At 1006, the method 1000 may include receiving, using the first wireless transceiver 212, the receiver indication of the amount of money. Next, at 1008, the method 1000 may include displaying, using a first display unit in the first mobile device 202, the receiver indication of the amount of money. Further, at 1010, the method 1000 may include receiving, using a first input device comprised in the first mobile device 202, an acceptance associated with the receiver indication. Further, the transmitting of the one or more first read commands may be based on the acceptance.

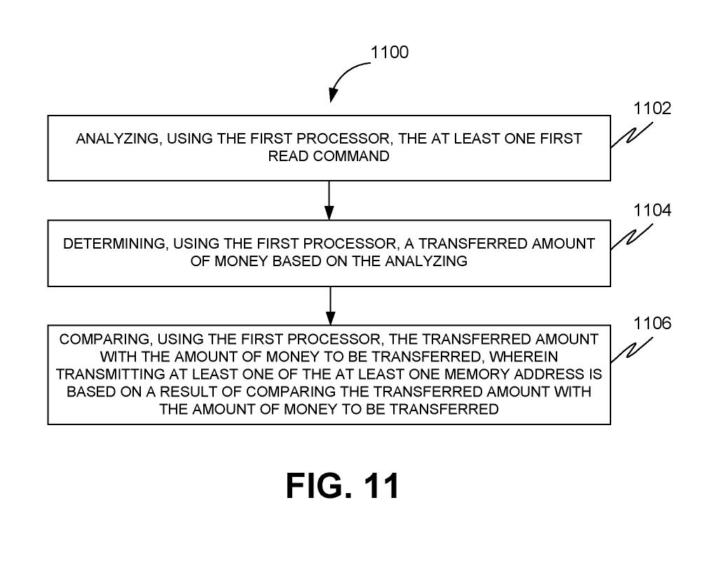

FIG. 11 illustrates a flowchart of a method 1100 for checking the transferred amount of money, in accordance with some embodiments. At 1102, the method 1100 may include analyzing, using the first processor 208, the one or more first read commands. Further, at 1104, the method 1100 may include determining, using the first processor 208, a transferred amount of money based on the analyzing. Next, at 1106, the method 1100 may include comparing, using the first processor 208, the transferred amount with the amount of money to be transferred. Further, transmitting one or more of the one or more memory addresses may be based on a result of comparing the transferred amount with the amount of money to be transferred.

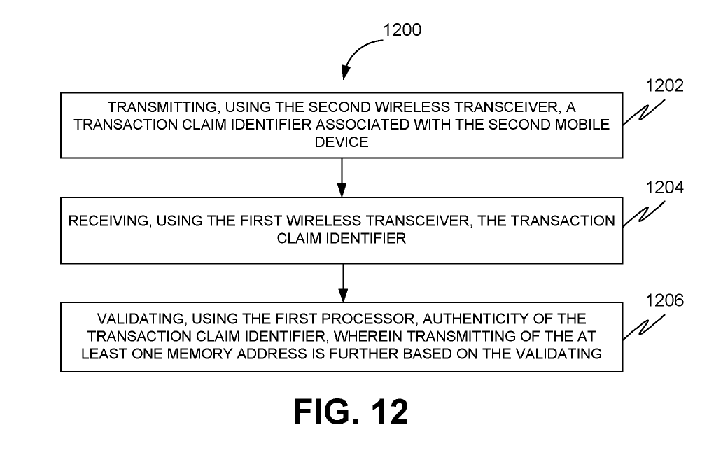

FIG. 12 illustrates a flowchart of a method 1200 for authenticating the transaction, in accordance with some embodiments. At 1202, the method 1200 may include transmitting, using the second wireless transceiver 220, a transaction claim identifier associated with the second mobile device 204. Further, at 1204, the method 1200 may include receiving, using the first wireless transceiver 212, the transaction claim identifier. At 1206, the method 1200 may include validating, using the first processor 208, the authenticity of the transaction claim identifier. Further, transmitting of the one or more memory addresses may be further based on the validating.

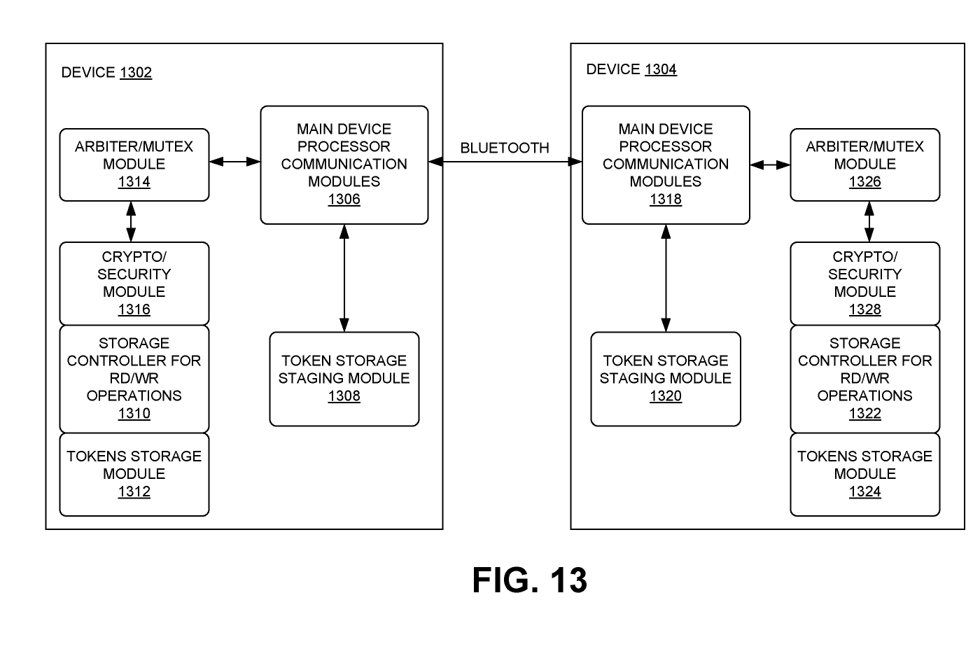

FIG. 13 is a block diagram of a first mobile device 1302 configured for transferring a digital token to a second mobile device 1304 based on sensor data, in accordance with some embodiments. The first mobile device 1302 may include processor and communication modules 1306, a token storage staging module 1308, a storage controller 1310, a tokens storage module 1312, an arbiter module 1314 and a security module 1316. Similarly, the second mobile device 1304 may include processor and communication modules 1318, a token storage staging module 1320, a storage controller 1322, a tokens storage module 1324, an arbiter module 1326 and a security module 1328.

The processor and communication modules 1306 and the processor and communication modules 1318 may be configured to execute various operations on the respective devices. Further, the processor and communication modules 1306 and the processor and communication modules 1318 may be configured to perform communication between the first mobile device 1302 and the second mobile device 1304.

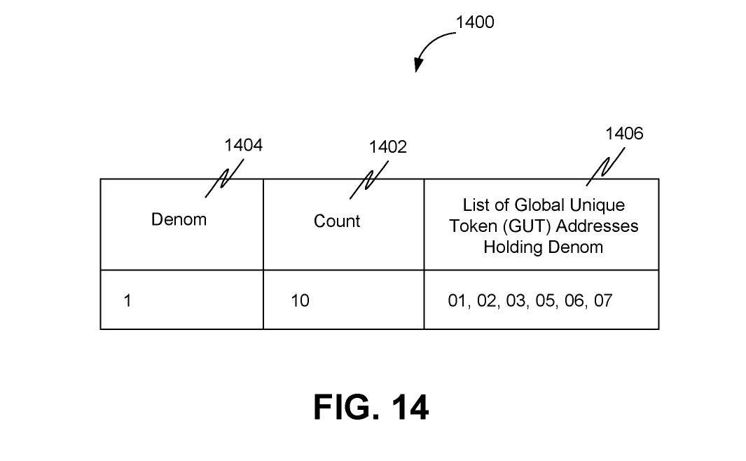

Each of the token storage staging module 1308 and the token storage staging module 1320 may be configured to store a staging table. The staging table may include information about one or more of denomination of digital tokens, count of digital tokens and memory addresses holding the digital tokens on the respective devices. FIG. 14 shows a staging table 1400 in accordance with an exemplary embodiment. The staging table 1400 indicates that a corresponding device includes 10 digital tokens (in column count 1402) of denomination ‘1’ (in column denom 1404). Further, the staging table 1400 shows the list of Global Unique Token (GUT) addresses (in the corresponding memory) holding digital tokens in the column 1406.

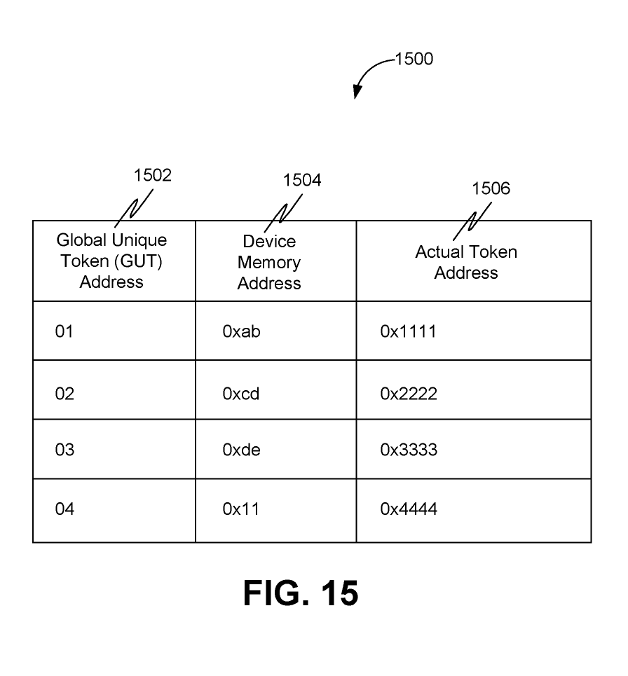

Each of the tokens storage module 1312 and the tokens storage module 1324 may be configured to store the one or more digital tokens on the respective devices. The one or more digital tokens may be stored in known addresses in each of the tokens storage module 1312 and the tokens storage module 1324. FIG. 15 shows a storage element 1500 in accordance with an exemplary embodiment. A column 1502 indicates the Global Unique Token (GUT) addresses of 4 digital tokens. A column 1504 indicates device memory addresses of the 4 digital tokens. For each row in the storage element 1500, the value in the column 1502 and the value in the column 1504 may be combined using a mathematical operation to obtain the actual token address of the corresponding digital token (column 1506). The actual token address may be used to locate and retrieve a digital token.

Each of the storage controller 1310 and the storage controller 1322 may be configured to perform read and write operations in the tokens storage module 1312 and the tokens storage module 1324, respectively. Accordingly, one or both of the storage controller 1310 and the storage controller 1322 may be designed such that whenever a request reading from a specific location is received, one or more of the following operations may be performed:
Reading the data
Erasing the data by writing the data sent by the receiving device to the same address
Reading second time to the same address to check if erased happened
Sending the second read data encrypted to the receiving device
If this write is not successful, ownership transfer transaction may be considered unsuccessful.

Each of the security module 1316 and the security module 1328 may be configured to provide encryption or decryption of data for secure communications between the first mobile device 1302 and the second mobile device 1304.

According to some embodiments, an Ownership Transfer Mode Protocol may be provided to ensure safe and secure transfer of one or more digital tokens. Accordingly, when a sending device (such as the first mobile device 1302) enters an Ownership Transfer Mode, the Ownership Transfer Mode Protocol ensures that the sending device abides by the following restrictions:
The sending device cannot issue read/write commands to storage/memory (such as the tokens storage module 1312) to itself at locations where the digital tokens reside
The sending device may only send addresses of where the tokens are stored to the receiving device (such as the second mobile device 1304). The receiving device performs a read operation followed by a write operation to erase the digital token(s)
The sending device can only write to a storage mutex chip (such as the arbiter module 1314), but not storage itself (such as the tokens storage module 1312).
For every claim command by the receiving device, both the sending device and the receiving device validate the corresponding digital token
All events have timeout countdown
Every digital token may be represented with public and private keys
Once the receiving device receives the digital token, it may create the public and private keys for the digital token.

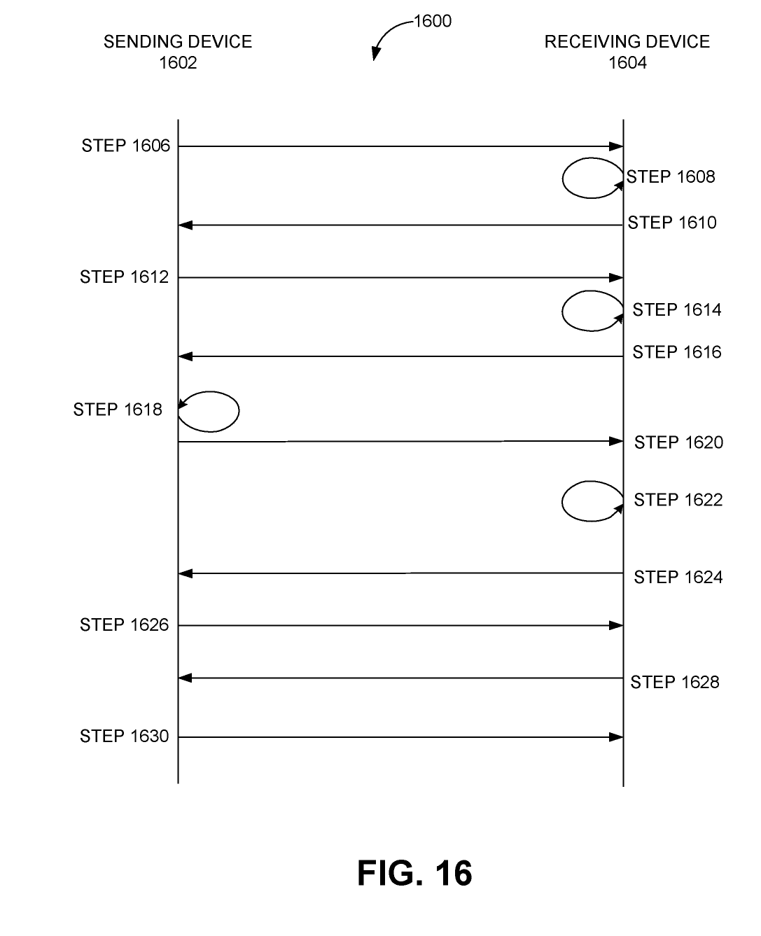

FIG. 16 is a sequence diagram 1600 showing the communication between a sending device 1602 and a receiving device 1604 in accordance with some embodiments. At step 1606, the sending device 1602 sends all its Global Token Addresses (GTA) to the receiving device 1604. Further, the sending device 1602 sends the amount to transfer. The amount to transfer may be provided by a user of the sending device 1602.

Further, at step 1608, the receiving device 1604 gets all the GTAs of the sending device 1602. Then, the receiving device 1604 verifies that the GTAs are authentic according to a central authority, such as for example, an organization designated to issue digital currency. Further, the receiving device 1604, receives information about the amount to transfer. A user of the receiving device 1604 may confirm the amount to transfer on the receiving device.

Then, at step 1610, the receiving device 1604 sends encrypted information to the sending device 1602. First, the receiving device 1604 randomly generates a Device Transaction Claim ID (TCID) for the transaction based on a Device Claim ID (DCID) assigned for the receiving device 1604 by, for example, the central authority. Further, the receiving device 1604 may generate a transfer key pair (receiver public and private keys). Yet further, the receiving device 1604 stores the receiver private key in a local storage device buffer. Further, the receiving device 1604 sends an information package including the TCID, the receiver public key, and the claimed amount. Further, the receiving device 1604 computes and stores an expected arbiter module writer information results.

Next, at step 1612, the sending device 1602 receives the encrypted information from the receiving device 1604. The encrypted information includes the Device generated Tx Claim ID (TCID). Then, the sending device 1602 verifies the TCID. Next, the sending device 1602 writes the information in the information package on a corresponding arbiter module. Then, the sending device 1602 generates a “Set Pub Key” to a corresponding storage device, such that the storage device sets the “Claimer Pub Key buffer” to the receiver public key. Then, the storage device verifies that the receiver public key is from a valid device according to the central authority. Then, the sending device 1602 sets the receiver public key to be used later to auto-encrypt data with. Then, the sending device 1602 generates result of operations of setting to the corresponding arbiter module. Thereafter, the sending device 1602 sends the results to the receiving device 1604.

Next, at 1614, the receiving device 1604 obtains previous operation results data. Further, the receiving device 1604 checks if the results data matches expected value from the step 1610. If the results data matches, then the process proceeds further.

Further, at 1616, the receiving device 1604 randomly picks a single address from the GTA claim range. Then, the receiving device 1604 randomly generates an erase data to be sent to sending device 1602. Next, the receiving device 1604 sends a claim command to the sending device 1602 with the picked GTA, and erase data in encrypted format.

Then, at 1618, the sending device 1602 receives the claim command with the picked GTA, and erase data. Then, the sending device 1602 checks if the receiving device 1604 has confirmed the claim amount. Then, the sending device 1602 relays this to the corresponding arbiter module.

Then, at 1620, the arbiter module corresponding to the sending device 1602 issues the claim command with the picked GTA, and erase data to the storage device corresponding to the sending device 1602. Further, the storage device reads data (i.e. the token) at the picked GTA from the receiving device 1604 and decrypts it using the private key for the token when it was loaded. Next, the storage device erases data at the picked GTA with the erase token data. Then, the storage device reads again at the picked GTA. Then, the storage device returns the read data in an encrypted format (using the receiver public key from the step 1612 above). Then, the receiver device 1604 can decrypt the read data to verify if the erase token data was successfully written in the picked GTA in place of the token. Accordingly, the arbiter module sends an encrypted data to the receiving device 1604.

Then, at 1622, the receiving device 1604 receives the encrypted data. Then, the encrypted data is auto-decrypted using the receiver private key (from the step 1610 above), and a verification of whether the received data matches erase-data (sent in the step 1616) is performed. Then, the receiving device 1604 generates new token storage key-pair, encrypts the token with the new public key and writes the encrypted token to the storage device corresponding to the receiving device 1604. Next, the receiving device 1604 sets a lock bit. Further, the receiving device 1604 updates the staging table of the receiving device 1604. Then, the step 1616 is repeated, until all GTA addresses in the range have been picked to match expected request amount.

Next, at 1624, the receiving device 1604 sends an erase GUT address range command to the sending device 1602. Further, at 1626, the sending device 1602 deletes all GUT address from the staging table of the sending device 1602. Then, the sending device 1602 sends a first confirmation message to the receiving device 1604. Next, at 1628, the receiving device 1604 receives the first confirmation message. Then, the receiving device 1604 send a second confirmation message to the sending device 1602. Thereafter, the receiving device 1604 enters a sleeping mode. Further, at step 1630, the sending device 1602 receives the second confirmation message and enters a sleeping mode.

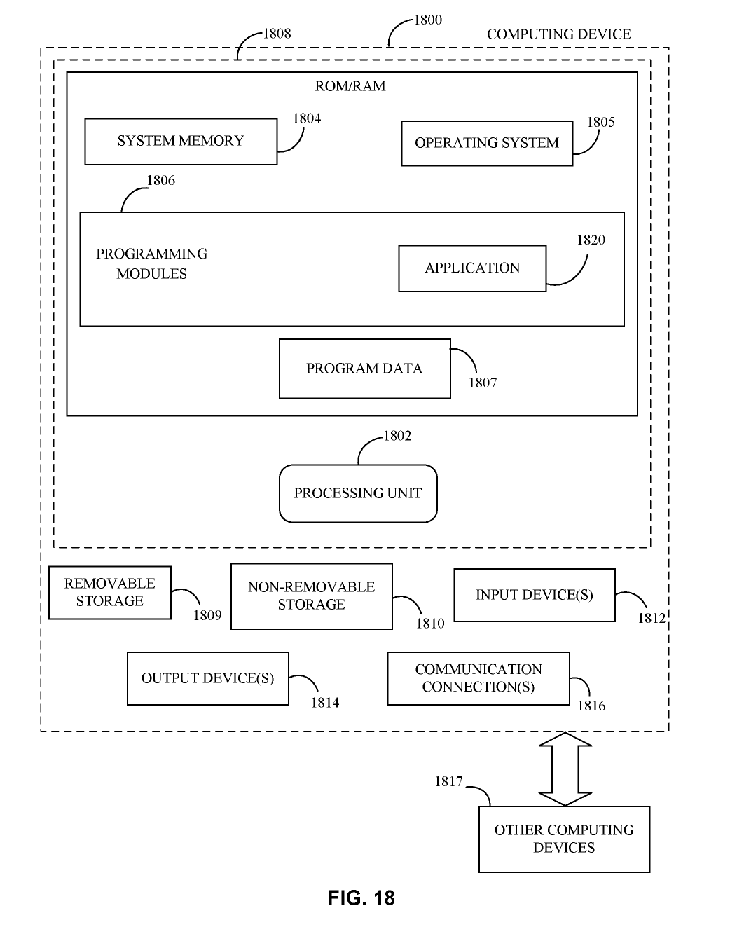

FIG. 18 is a block diagram of a system including computing device 1800. Consistent with an embodiment of the disclosure, the aforementioned memory storage and processing unit may be implemented in a computing device, such as computing device 1800 of FIG. 18. Any suitable combination of hardware, software, or firmware may be used to implement the memory storage and processing unit. For example, the memory storage and processing unit may be implemented with computing device 1800 or any of other computing devices 1818, in combination with computing device 1800. The aforementioned system, device, and processors are examples and other systems, devices, and processors may comprise the aforementioned memory storage and processing unit, consistent with embodiments of the disclosure.

With reference to FIG. 18, a system consistent with an embodiment of the disclosure may include a computing device or cloud service, such as computing device 1800. In a basic configuration, computing device 1800 may include at least one processing unit 1802 and a system memory 1804. Depending on the configuration and type of computing device, system memory 1804 may comprise, but is not limited to, volatile (e.g. random-access memory (RAM)), non-volatile (e.g. read-only memory (ROM)), flash memory, or any combination. System memory 1804 may include operating system 1805, one or more programming modules 1806, and may include a program data 1807. Operating system 1805, for example, may be suitable for controlling computing device 1800's operation. In one embodiment, programming modules 1806 may include image encoding module, machine learning module and image classifying module. Furthermore, embodiments of the disclosure may be practiced in conjunction with a graphics library, other operating systems, or any other application program and is not limited to any particular application or system. This basic configuration is illustrated in FIG. 18 by those components within a dashed line 1808.

Computing device 1800 may have additional features or functionality. For example, computing device 1800 may also include additional data storage devices (removable and/or non-removable) such as, for example, magnetic disks, optical disks, or tape. Such additional storage is illustrated in FIG. 18 by a removable storage 1809 and a non-removable storage 1810. Computer storage media may include volatile and nonvolatile, removable and non-removable media implemented in any method or technology for storage of information, such as computer-readable instructions, data structures, program modules, or other data. System memory 1804, removable storage 1809, and non-removable storage 1810 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1800. Any such computer storage media may be part of device 1800. Computing device 1800 may also have input device(s) 1812 such as a keyboard, a mouse, a pen, a sound input device, a touch input device, etc. Output device(s) 1814 such as a display, speakers, a printer, etc. may also be included. The aforementioned devices are examples and others may be used.

Computing device 1800 may also contain a communication connection 1816 that may allow device 1800 to communicate with other computing devices 1818, such as over a network in a distributed computing environment, for example, an intranet or the Internet. Communication connection 1816 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 1804, including operating system 1805. While executing on processing unit 1802, programming modules 1806 (e.g., application 1820) may perform processes including, for example, one or more stages of methods 300, 400 500, 600, 700, 800, 900, 1000, 1100, 1200, and 1600 as described above. The aforementioned process is an example, and processing unit 1802 may perform other processes.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, multiprocessor systems, microprocessor-based or programmable consumer electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example, but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may, in fact, be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the invention has been explained in relation to its preferred embodiment, it is to be understood that many other possible modifications and variations can be made without departing from the spirit and scope of the invention.

I/We claim:

1. A method of wirelessly transferring a digital token between a first mobile device and a second mobile device based on sensor data, wherein the first mobile device comprises a first sensor, a first processor, a first memory and a first wireless transceiver, wherein the second mobile device comprises a second sensor, a second processor, a second memory and a second wireless transceiver, the method comprising:
generating, using the first sensor, a first sensor data representing a physical variable associated with the first mobile device;
generating, using the second sensor, a second sensor data representing the physical variable associated with the second mobile device;
transmitting, using the first wireless transceiver, at least one memory address associated with at least one digital token based on generating of each of the first sensor data and the second sensor data;
receiving, using the second wireless transceiver, the at least one memory address associated with the at least one digital token based on detecting of each of the first physical variable and the second physical variable;
transmitting, using the second wireless transceiver, at least one first read command associated with the at least one memory address;
receiving, using the first wireless transceiver, the at least one first read command;
retrieving, using the first memory, at least one digital token stored in the at least one memory address based on receiving the at least one first read command;
transmitting, using the first wireless transceiver, the at least one digital token;
receiving, using the second wireless transceiver, the at least one digital token;
storing, using the second memory, the at least one digital token in the second mobile device;
transmitting, using the second wireless transceiver, at least one erase command comprising at least one erasure data;
receiving, using the first wireless transceiver, the at least one erase command; and
storing, using the first memory, the at least one erasure data in the at least one memory address based on receiving the at least one erase command.

2. The method of claim 1 further comprising:
transmitting, using the second wireless transceiver, at least one second read command associated with the at least one memory address;
receiving, using the first wireless transceiver, the at least one second read command;
retrieving, using the first memory, at least one actual data stored in the at least one memory address based on receiving the at least one second read command;
transmitting, using the first wireless transceiver, the at least one actual data;
receiving, using the second wireless transceiver, the at least one actual data;
comparing, using the second processor, the at least one actual data with the at least one erasure data; and
determining, using the second processor, a successful transfer of the at least one digital token based on a result of the comparing.

3. The method of claim 2 further comprising:
transmitting, using the second wireless transceiver, a second public key associated with the second mobile device;
receiving, using the first wireless transceiver, the second public key;
encrypting, using the first processor, the at least one actual data using the second public key; and
decrypting, using the second processor, the at least one actual data using a second private key associated with the second public key.

4. The method of claim 1 further comprising:
transmitting, using the second wireless transceiver, a second public key associated with the second mobile device;
receiving, using the first wireless transceiver, the second public key;
decrypting, using the first processor, the at least one digital token based on a first private key associated with the first mobile device; and
encrypting, using the first processor, the at least one digital token based on the second public key.

5. The method of claim 4 further comprising:
decrypting, using the second processor, the at least one digital token based on the second private key; and
generating, using the second processor, each of a third private key and a third public key associated with the second mobile device;
encrypting, using the second processor, at least one digital token based on the third public key; and
storing, using the second memory, the at least one digital token subsequent to encrypting the at least one digital token with the third private key.

6. The method of claim 1 further comprising:
generating, using the second processor, at least one random number; and
generating, using the second processor, the at least one erasure data based on the at least one random number.

7. The method of claim 1 further comprising:
receiving, using a first input device, a sender indication of an amount of money to be transferred by the first mobile device, wherein a digital token of the at least one digital token is associated with a predetermined monetary value;
transmitting, using the first wireless transceiver, the sender indication of the amount of money;
receiving, using the second wireless transceiver, the sender indication of the amount of money;
receiving, using a second input device, a receiver indication of amount of money to be received by the second mobile device;
comparing, using the second processor, the sender indication with the receiver indication; and
confirming, using the second processor, the amount of money to be transferred, wherein the transmitting of the at least one first read command is based on the confirming.

8. The method of claim 1 further comprising:
receiving, using a second input device comprised in the second mobile device, a receiver indication of amount of money to be received by the second mobile device, wherein a digital token of the at least one digital token is associated with a predetermined monetary value;
transmitting, using the second wireless transceiver, the receiver indication of the amount of money;
receiving, using the first wireless transceiver, the receiver indication of the amount of money;
displaying, using a first display unit in the first mobile device, the receiver indication of the amount of money;
receiving, using a first input device comprised in the first mobile device, an acceptance associated with the receiver indication, wherein the transmitting of the at least one first read command is based on the acceptance.

9. The method of claim 7 further comprising:
analyzing, using the first processor, the at least one first read command;
determining, using the first processor, a transferred amount of money based on the analyzing; and
comparing, using the first processor, the transferred amount with the amount of money to be transferred, wherein transmitting at least one of the at least one memory address is based on a result of comparing the transferred amount with the amount of money to be transferred.

10. The method of claim 1 further comprising:
transmitting, using the second wireless transceiver, a transaction claim identifier associated with the second mobile device;
receiving, using the first wireless transceiver, the transaction claim identifier; and
validating, using the first processor, authenticity of the transaction claim identifier, wherein transmitting of the at least one memory address is further based on the validating.

11. The method of claim 1 further comprising validating, using the second processor, authenticity of the at least one memory address based on at least one characteristic of the at least one memory address.

12. A first mobile device configured for transferring a digital token to a second mobile device based on sensor data, wherein the second mobile device comprises a second sensor, a second processor, a second memory and a second wireless transceiver, the first mobile device comprising:
a first sensor configured for generating a first sensor data representing a physical variable associated with the first mobile device, wherein the second sensor is configured for generating a second sensor data representing the physical variable associated with the second mobile device;
a first wireless transceiver configured for:
transmitting at least one memory address associated with at least one digital token based on generating of each of the first sensor data and the second sensor data, wherein the second mobile device comprises a second wireless transceiver configured for receiving the at least one memory address associated with the at least one digital token based on detecting of each of the first physical variable and the second physical variable;
receiving at least one first read command, wherein the second wireless transceiver is configured for transmitting the at least one first read command;
transmitting the at least one digital token, wherein the second wireless transceiver is configured for receiving the at least one digital token; and
receiving at least one erase command comprising at least one erasure data, wherein the second wireless transceiver is configured for transmitting the at least one erase command;
a first memory configured for:
retrieving at least one digital token stored in the at least one memory address based on receiving the at least one first read command, wherein the second mobile device comprises a second memory configured for storing the at least one digital token in the second mobile device; and
storing the at least one erasure data in the at least one memory address based on receiving the at least one erase command.

13. The first mobile device of claim 12, wherein the first wireless transceiver is further configured for:
receiving at least one second read command associated with the at least one memory address, wherein using the second wireless transceiver is further configured for transmitting the at least one second read command; and
transmitting at least one actual data stored in the at least one memory address, wherein the second wireless transceiver is further configured for receiving the at least one actual data, wherein the second processor is further configured for comparing the at least one actual data with the at least one erasure data, wherein the second processor further configured for determining a successful transfer of the at least one digital token based on a result of the comparing, wherein the first memory is further configured for retrieving the at least one actual data stored in the at least one memory address based on receiving the at least one second read command.

14. The first mobile device of claim 13, wherein the first wireless transceiver is further configured for receiving a second public key associated with the second mobile device, wherein the second wireless transceiver is further configured for transmitting the second public key, wherein the first processor is further configured for encrypting the at least one actual data using the second public key, wherein the second processor is further configured for decrypting the at least one actual data using a second private key associated with the second public key.

15. The first mobile device of claim 12, wherein the first wireless transceiver is further configured for receiving a second public key associated with the second mobile device, wherein the second wireless transceiver is further configured for transmitting the second public key, wherein the first processor is further configured for:
decrypting the at least one digital token based on a first private key associated with the first mobile device; and
encrypting the at least one digital token based on the second public key.

16. The first mobile device of claim 14, wherein the second processor is further configured for:
decrypting the at least one digital token based on the second private key; and
generating each of a third private key and a third public key associated with the second mobile device; and
encrypting at least one digital token based on the third public key, wherein the second memory is further configured for storing the at least one digital token subsequent to encrypting the at least one digital token with the third private key.

17. The first mobile device of claim 12, wherein the second processor is further configured for:
generating at least one random number; and
generating the at least one erasure data based on the at least one random number.

18. The first mobile device of claim 12 further comprising a first input device configured for receiving a sender indication of an amount of money to be transferred by the first mobile device, wherein a digital token of the at least one digital token is associated with a predetermined monetary value, wherein the first wireless transceiver is further configured for transmitting the sender indication of the amount of money, wherein the second wireless transceiver is further configured for receiving the sender indication of the amount of money, wherein the second mobile device comprises a second input device configured for receiving a receiver indication of amount of money to be received by the second mobile device, wherein the second processor is further configured for:
comparing the sender indication with the receiver indication; and
confirming the amount of money to be transferred, wherein the transmitting of the at least one first read command is based on the confirming.

19. The first mobile device of claim 12, wherein the first wireless transceiver is further configured for receiving a receiver indication of the amount of money, wherein the second wireless transceiver is further configured for transmitting the receiver indication of the amount of money, wherein the second mobile device comprises a second input device configured for receiving a receiver indication of amount of money to be received by the second mobile device, wherein a digital token of the at least one digital token is associated with a predetermined monetary value, wherein the first mobile device further comprises:
a first display unit configured for displaying the receiver indication of the amount of money; and
a first input device configured for receiving an acceptance associated with the receiver indication, wherein the transmitting of the at least one first read command is based on the acceptance.

20. The first mobile device of claim 18, wherein the first processor is further configured for:
analyzing the at least one first read command;
determining a transferred amount of money based on the analyzing; and
comparing the transferred amount with the amount of money to be transferred, wherein transmitting at least one of the at least one memory address is based on a result of comparing the transferred amount with the amount of money to be transferred.

21. The first mobile device of claim 12, wherein the first wireless transceiver is further configured for receiving a transaction claim identifier associated with the second mobile device, wherein the second wireless transceiver is further configured for transmitting the transaction claim identifier, wherein the first processor is further configured for validating authenticity of the transaction claim identifier, wherein transmitting of the at least one memory address is further based on the validating.

22. The first mobile device of claim 12, wherein the second processor is further configured for validating authenticity of the at least one memory address based on at least one characteristic of the at least one memory address.

23. A system for facilitating wireless transfer of a digital token between a first mobile device and a second mobile device based on sensor data, wherein the first mobile device comprises a first sensor, a first processor, a first memory and a first wireless transceiver, wherein the second mobile device comprises a second sensor, a second processor, a second memory and a second wireless transceiver, the system comprising:
a communication device configured for:
receiving a first sensor data representing a physical variable associated with the first mobile device;
receiving a second sensor data representing the physical variable associated with the second mobile device; and
transmitting an indication of a transfer event to each of the first mobile device and the second mobile device; and
a processing device configured for:
analyzing each of the first sensor data and the second sensor data; and
detecting the transfer event based on the analyzing, wherein
the first wireless transceiver is configured for:
receiving the indication of the transfer event from the communication device;
transmitting at least one memory address associated with at least one digital token based on receiving the indication of the transfer event, wherein the second wireless transceiver is configured for receiving the indication of the transfer event from the communication device; and receiving the at least one memory address associated with the at least one digital token based on the indication of the transfer event;
receiving at least one first read command, wherein the second wireless transceiver is configured for transmitting the at least one first read command;
transmitting the at least one digital token, wherein the second wireless transceiver is configured for receiving the at least one digital token; and
receiving at least one erase command comprising at least one erasure data, wherein the second wireless transceiver is configured for transmitting the at least one erase command, wherein
the first memory is configured for:
retrieving at least one digital token stored in the at least one memory address based on receiving the at least one first read command, wherein the second memory is configured for storing the at least one digital token in the second mobile device; and
storing the at least one erasure data in the at least one memory address based on receiving the at least one erase command.
